(19) United States
(12) Patent Application Publication
(10) Pub. No.: US 2026/0236451 A1
(43) Pub. Date: Aug. 13, 2026

(54) ENHANCING LARGE LANGUAGE MODELS WITH SYMBOLIC KNOWLEDGE REPRESENTATIONS

(71) Applicant: National Technology & Engineering Solutions of Sandia, LLC, Albuquerque, NM (US)

(72) Inventors: Douglas Cale Crowder, Albuquerque, NM (US); Jonathan Edward Compton, Albuquerque, NM (US); Edward Ralph Carroll, Albuquerque, NM (US); Jaimie Miller Murdock, Albuquerque, NM (US); Brendan Donohoe, Albuquerque, NM (US)

(21) Appl. No.: 19/048,375

(22) Filed: Feb. 7, 2025

(51) Int. Cl. G06F 16/23; G06F 16/245; G06N 3/042; G06N 3/0475

(52) U.S. Cl. CPC G06F 16/2365; G06F 16/245

(57) ABSTRACT

An illustrative embodiment provides a computer-implemented method. The method comprises using a processor set to create a first large language model for generating symbolic knowledge representations based on a set of data received from multi-modal documents from a plurality of data sources. The processor set generates a number of symbolic knowledge representations based on the set of data. The processor set receives a query comprising textual information received through a user-input from a user. The processor set filters the number of symbolic knowledge representations to identify a portion of symbolic knowledge representation based on the textual information in the query. The processor set generates a response based on the portion of symbolic knowledge representation using a second large language model. The processor set validates the response using the portion of symbolic knowledge representation. The processor set returns the response to the user based on the validation.

### STATEMENT OF GOVERNMENT INTEREST

This invention was made with Government support under Contract No. DE-NA0003525 awarded by the United States Department of Energy/National Nuclear Security Administration. The U.S. Government has certain rights in the invention.

### BACKGROUND INFORMATION

### 1. Field

The present disclosure relates generally to enhancing large language models with symbolic knowledge representations.

### 2. Background

Insight extraction from semi-structured and unstructured documents refers to the process of deriving meaningful information from text or data that lacks a rigid structure. Insight extraction involves analyzing and interpreting information from text data that lacks a standardized format or organization.

Semi-structured data such as emails or log files usually contain some identifiable structures like tags or metadata but lack a uniform format. In a similar fashion, unstructured data such as plain text from articles, social media posts, or customer feedback usually has minimal organization and requires advanced processing before it can be used for other purposes.

In this case, insight extraction in above mentioned contexts often involves using natural language processing (NLP) to analyze, categorize, and retrieve useful information to support decision-making, customer understanding, or trend identification.

### SUMMARY

An illustrative embodiment provides a computer-implemented method. The method comprises using a processor set to create a first large language model for generating symbolic knowledge representations based on a set of data received from multi-modal documents from a plurality of data sources. The processor set generates a number of symbolic knowledge representations based on the set of data. Each node in the number of symbolic knowledge representations represents a concept and each edge in the number of symbolic knowledge representations represents a relationship between concepts. The processor set receives a query comprising textual information received through a user-input from a user. The processor set filters the number of symbolic knowledge representations to identify a portion of symbolic knowledge representation based on the textual information in the query. The processor set generates a response based on the portion of symbolic knowledge representation using a second large language model. The processor set validates the response using the portion of symbolic knowledge representation. The processor set returns the response to the user based on the validation.

Another illustrative embodiment provides a computer system. The system comprises a processor set, a set of one or more computer-readable storage media, and program instructions stored on the set of one or more storage media to cause the processor set to perform operations comprising creating a first large language model for generating symbolic knowledge representations based on a set of data received from multi-modal documents from a plurality of data sources; generating a number of symbolic knowledge representations based on the set of data, where each node in the number of symbolic knowledge representations represents a concept and each edge in the number of symbolic knowledge representations represents a relationship between concepts; receiving a query comprising textual information received through a user-input from a user; filtering the number of symbolic knowledge representations to identify a portion of symbolic knowledge representation based on the textual information in the query; generating a response based on the portion of symbolic knowledge representation using a second large language model; validating the response using the portion of symbolic knowledge representation; and returning the response to the user based on the validation.

Another illustrative embodiment provides a computer program product. The computer program product comprises a set of one or more computer-readable storage media, and program instructions stored in the set of one or more storage media to perform operations comprising using a processor set to create a first large language model for generating symbolic knowledge representations based on a set of data received from multi-modal documents from a plurality of data sources; generating a number of symbolic knowledge representations based on the set of data, where each node in the number of symbolic knowledge representations represents a concept and each edge in the number of symbolic knowledge representations represents a relationship between concepts; receiving a query comprising textual information received through a user-input from a user; filtering the number of symbolic knowledge representations to identify a portion of symbolic knowledge representation based on the textual information in the query; generating a response based on the portion of symbolic knowledge representation using a second large language model; validating the response using the portion of symbolic knowledge representation; and returning the response to the user based on the validation.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a model management environment in accordance with an illustrative embodiment;

FIG. 3 depicts a flowchart illustrating a process for generating response for a query from a user in accordance with an illustrative embodiment;

FIG. 4 depicts a flowchart illustrating a process for validating the response in accordance with an illustrative embodiment;

FIG. 5 depicts a flowchart illustrating a process for finetuning the first large language model in accordance with an illustrative embodiment; and

FIG. 6 is a block diagram of a data processing system in accordance with an illustrative embodiment.

### DETAILED DESCRIPTION

The illustrative embodiments recognize and take into account a number of considerations. For example, the illustrative embodiments recognize and take into account that a trusted method to quickly validate critical events needs to be developed even when information streams contain misinformation. The illustrative embodiments recognize and take into account that an artificial intelligence system for validating critical events can be developed by combining large language models (LLMs) with symbolic knowledge representations.

The illustrative embodiments recognize and take into account that the critical events can be anticipated and validated by using an automated tool that combines multimodal data and high-resolution spatiotemporal metadata.

Thus, illustrative embodiments of the present invention provide a computer implemented method, computer system, and computer program product for validating a response for a query related to a critical event. The method comprises using a processor set to create a first large language model for generating symbolic knowledge representations based on a set of data received from multi-modal documents from a plurality of data sources. The processor set generates a number of symbolic knowledge representations based on the set of data. Each node in the number of symbolic knowledge representations represents a concept and each edge in the number of symbolic knowledge representations represents a relationship between concepts. The processor set receives a query comprising textual information received through a user-input from a user. The processor set filters the number of symbolic knowledge representations to identify a portion of symbolic knowledge representation based on the textual information in the query. The processor set generates a response based on the portion of symbolic knowledge representation using a second large language model. The processor set validates the response using the portion of symbolic knowledge representation. The processor set returns the response to the user based on the validation.

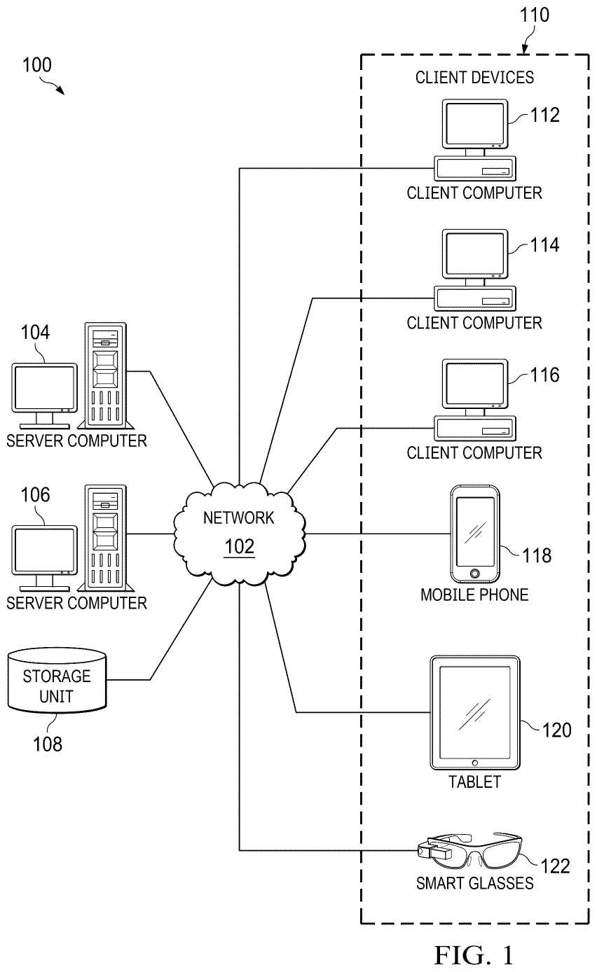

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

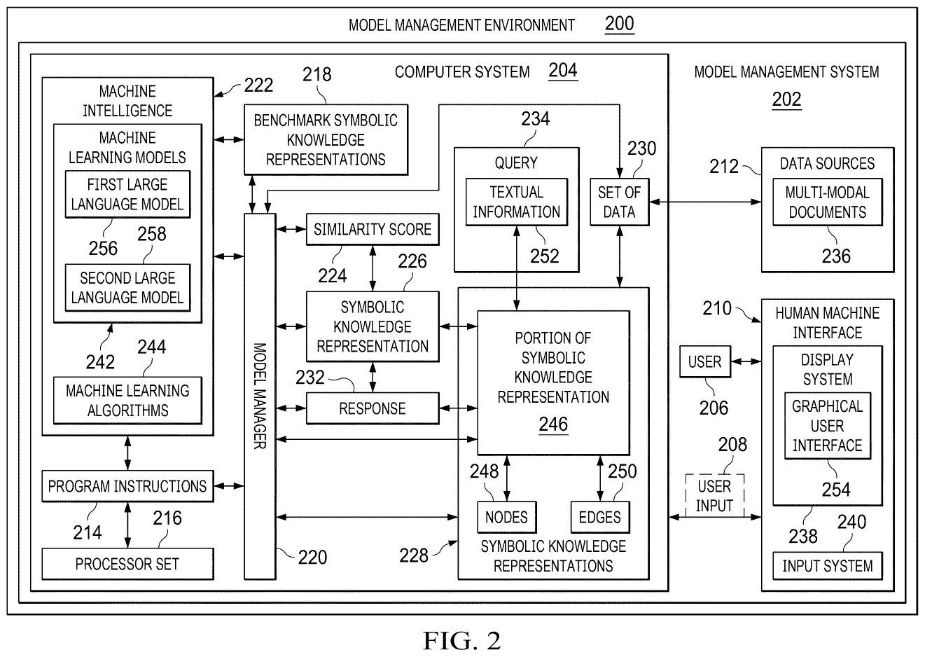

With reference now to FIG. 2, an illustration of a block diagram of a model management environment is depicted in accordance with an illustrative embodiment. In this illustrative example, model management environment 200 includes components that can be implemented in hardware such as the hardware shown in network data processing system 100 in FIG. 1.

In this illustrative example, model management system 202 in model management environment 200 generates first large language model 256 and second large language model 258 for creating and validating response 232 in response to query 234 received from user 206 via user input 208. In this illustrative example, first large language model 256 and second large language model 258 utilize supporting technologies such as retrieval augmented generation (RAG) that relies on vector databases as well as chunkers and embedders for processing data.

In this illustrative example, model management system 202 includes computer system 204 which includes model manager 220.

Model manager 220 can be implemented in software, hardware, firmware, or a combination thereof. When software is used, the operations performed by model manager 220 can be implemented in program instructions configured to run on hardware, such as a processor unit. When firmware is used, the operations performed by model manager 220 can be implemented in program instructions and data and stored in persistent memory to run on a processor unit. When hardware is employed, the hardware can include circuits that operate to perform the operations in model manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 also includes machine intelligence 222. Machine intelligence 222 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 222 is continuously refined over time through trial and error. Equivalence of assets or products can be effectively performed by supervised machine learning, unsupervised learning, semi-supervised learning, and reinforcement learning so that products or assets that do not match descriptively can nevertheless be matched. Over time, the data model from machine learning can provide a greater degree of flexibility in matching machine intelligence 222.

Machine intelligence 222 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for generating first large language model 256 and second large language model 258 for creating and validating response 232 in response to query 234 received from user 206 via user input 208.

Machine learning models 242 involves using machine learning algorithms 244 to build computation models based on samples of data. The samples of data used for training are referred to as training data or training datasets. Machine intelligence 222 can make predictions without being explicitly programmed to make these predictions. Machine intelligence 222 can be used for training and retraining computation models for a number of different types of applications. These applications include, for example, medicine, financial services, healthcare, speech recognition, computer vision, or other types of applications.

In this illustrative example, machine learning models 242 can include a number of models. For example, machine learning models 242 can include a deep learning model such as first large language model 256 and second large language model 258. In this illustrative example, first large language model 256 and second large language model 258 belongs to a type of machine learning model designed to understand, generate, and manipulate human language.

In this illustrative example, machine learning algorithms 244 can include supervised machine learning algorithms, semi-supervised machine learning algorithms, reinforcement machine learning algorithms, and unsupervised machine learning algorithms. Supervised machine learning can train machine learning models using data containing both the inputs and desired outputs. Examples of machine learning algorithms include XGBoost, neural networks such as attention network, transformers, or any suitable neural networks, K-means clustering, and random forest.

In this illustrative example, computer system 204 can be implemented using a neurosymbolic architecture and foundation models. A neurosymbolic architecture seeks to combine neural networks with symbolic reasoning and human knowledge. Neural models have been immensely successful in analyzing and generating high-dimensional and unstructured real-world data but have challenges with complex reasoning. In contrast, symbolic models provide predictable and understandable performance even in low-data settings but struggle with unstructured data.

In this illustrative example, neurosymbolic architectures that compose neural and symbolic processing modules in a trainable analytics pipeline can be developed for detecting complex events from multimodal sensor data on low-resource platforms. In this example, neurosymbolic architectures can be finetuned via end-to-end training techniques such as symbolic components with neural proxies and differentiable logic.

This technique also leverages foundation models, which can be pre-trained via self-supervised training on large amounts of data to learn representations agnostic to downstream classification, generation, and other tasks. Foundation models can be easily targeted to a given task via weight finetuning and in-context learning methods. Foundation models, in the form of LLMs, and multimodal language models, such as Vision Language Models (VLMs), have been astonishingly successful for many tasks involving text and image modalities despite challenges such as hallucinations from large language models. However, these models struggle with spatiotemporal reasoning and handling sensory data types such as extended temporal traces.

Therefore, an integrated neurosymbolic architecture can be developed such that machine intelligence 222 is capable of sophisticated spatiotemporal reasoning over multimodal data that includes not only text and images from social media, scientific literature, news, or any suitable sources, but also sensory data opportunistically obtained from mobile devices, non-mobile devices and IoT devices and networks.

In this illustrative example, model manager 220 receives set of data 230 from multi-modal documents 236 from a plurality of data sources 212. Multi-modal documents 236 are documents that incorporate multiple types of information to convey message effectively. For example, multi-modal documents 236 can include sensor data, textual data such as textual information 252, graphical data, audio data, video data, or any other suitable information.

In this illustrative example, model manager 220 generates symbolic knowledge representations 228 based on set of data 230. Symbolic knowledge representations 228 are representations of knowledge in which symbols are used to convey meaning, relationships, and information related to a specific domain. For example, symbolic knowledge representations 228 can include mathematical formulas, knowledge graphs, ontologies, and semantic networks.

Symbolic knowledge representations 228 may optionally include nodes 248 and edges 250. In this illustrative example, nodes 248 represent concepts in symbolic knowledge representations 228 and edges 250 represent relationships between concepts represented by nodes 248 in symbolic knowledge representations 228. For example, nodes 248 can include a node for “Earthquake” and a node for “Tsunami”, and edges 250 can include edge, potentially represented by a directional arrow, for “can trigger” between node for “Earthquake” and node for “Tsunami” to indicate that the logical relationship between “Earthquake” and “Tsunami” is that earthquake can trigger tsunami.

In this illustrative example, model manager 220 can use first large language model 256 to generate symbolic knowledge representations 228 based on set of data 230. In this example, first large language model 256 can be trained using concepts and relationships between concepts from set of data 230. In this illustrative example, first large language model 256 can also be obtained by training using self-supervised learning or finetuning a foundation model using set of data 230.

In this illustrative example, model manager 220 can compare outputs from first large language model 256 with benchmark symbolic knowledge representations 218 to determine whether first large language model 256 is accurate for generating symbolic knowledge representations 228. Benchmark symbolic knowledge representations 218 are ground truths of symbolic knowledge representations 228 that are generated by trusted methods that generally include a human in the loop.

If first large language model 256 is not accurate for generating symbolic knowledge representations 228, model manager 220 can obtain first large language model 256 by finetuning a foundation model. In an alternative illustrative example, model manager 220 can also retrain first large language model 256 by adjusting parameters for first large language model 256 until first large language model 256 achieves certain pre-defined performance criteria. In this illustrative example, symbolic knowledge representations 228 that are generated by humans are no longer needed when first large language model 256 is validated because, in validating the symbolic knowledge representation, the methods for generating symbolic knowledge representations have also been validated.

In this illustrative example, the pre-defined performance criteria can include accuracy, completeness, succinctness, similarity, and spatiotemporal metrics. In this example, accuracy means that symbolic knowledge representations 228 should be accurate with respect to the multimodal data it was generated from. Completeness means that all information in the multimodal data should be represented in symbolic knowledge representations 228. In this illustrative example, symbolic knowledge representations 228 should at least capture the same information that can be captured in benchmark symbolic knowledge representations 218, including any high-resolution spatiotemporal data that can be used for reasoning. Further, succinctness means that symbolic knowledge representations 228 should not contain redundant information.

In addition, conversion from a multimodal corpus to a symbolic knowledge representation is underdetermined. The same multimodal data can be used to create two graphs, for instance, meeting all of the above criteria yet still being structurally distinct from one another. In this illustrative example, similarity metric is used to determine whether two symbolic knowledge representations are similar to one another when applied to similar domains. In this example, similarity can refer to sharing entities, relations, and hierarchical structure of two symbolic knowledge representations. In this illustrative example, automatically producing symbolic knowledge representation 228 that is similar to the benchmark symbolic knowledge representations 218 will aid in validation.

In addition, spatiotemporal metrics refer to the metric that determines whether symbolic knowledge representations 228 contain all relevant high-resolution spatiotemporal data from set of data 230.

In this illustrative example, symbolic knowledge representations 228 can be generated by first large language model 256 in a number of ways. For example, symbolic knowledge representations 228 can be generated by generating chunks of symbolic knowledge representations based on set of data 230. Because modern LLMs have finite “memories,” symbolic knowledge representations will first be generated for adjacent chunks of the text corpus, or singular images in the case of multimodal data. In this illustrative example, the chunk size and LLM prompts can be tuned to ensure that symbolic knowledge representations are accurate, complete, succinct, spatiotemporal, and similar.

In this example, performance of first large language model 256 can be measured by comparing symbolic knowledge representations 228 to benchmark symbolic knowledge representations 218 for a subset of the nodes and edges. In this illustrative example, similarity between symbolic knowledge representations 228 to benchmark symbolic knowledge representations 218 can be maximized by extracting relevant portions of the initial symbolic knowledge representations and providing them in the prompt for first large language model 256 when creating subsequent chunk.

In addition, first large language model 256 can be finetuned by utilizing existing datasets of knowledges and schemas of prompts for generating symbolic knowledge representations 228. In this illustrative example, model manager 220 can evaluate and validate performance and accuracy for first large language model 256 using benchmark symbolic knowledge representations 218.

In this illustrative example, chunks of symbolic knowledge representations can be combined to generate larger symbolic knowledge representations. In this example, chunks of symbolic knowledge representations can be combined using techniques to match entity and relation names directly or using embedding based methods such as TransE or LLMs to identify similar entities and relations.

It should be understood that this problem is related to the NP-complete sub-graph isomorphism problem, the problem can be made tractable by decomposing the symbolic knowledge representations into smaller symbolic knowledge representations as necessary. In an alternative example, agent-based methods can be used to search over symbolic knowledge representations for identifying the relevant subgraph.

In this illustrative example, first large language model 256 can incorporate multi-modal language models (MLLMs) for processing set of data 230 from multi-modal documents 236. For example, first large language model 256 can incorporate Vision language Models (VLMs) for processing image data.

In this illustrative example, first large language model 256 takes advantage of multi-modal documents 236 from data sources 212 to iteratively derive the most useful domain representations obtainable. Two primary sources of data are domain experts and multimodal data. In this example, domain experts provide abstract information from their own ideas and multimodal data provide an encoding of the semantic space that is available for empirical analysis. In this illustrative example, many types of data may be gathered from both sources. For example, types of data that are gathered can include statistical relationships among terms, feedback from domain experts, user search and navigation traces, and existing metadata relationships (e.g., cross-references or citations).

In addition, text analytic tools can be used to identify and extract concepts and concept relationships within a document or corpus. This method, in combination with a domain expert, can create a rudimentary knowledge graph. In this illustrative example, the domain expert then enhances the rudimentary knowledge graph with logical constructs and named relationships by using the statistical relationships and feedback. By such a method, a concept becomes an axiom of a knowledge graph, with an expanded definition, associated attributes, and formal logical constructs.

For example, a simple hierarchy can be described by relationships such as “is_a”, “has_a”, or “is_part_of”. In this illustrative example, other forms of logical expressions can also be added beyond hierarchical relations. Further expressions may include types of knowledge such as realism, empiricism, positivism, and post-modernism, types of categories such as substances, properties, relations, states of affairs, events, particularity vs. universality, and abstractness vs. necessity. Together, these logical constructs are the basis for reasoning and inference for training first large language model 256.

As depicted, model manager 220 receives query 234 through user input 208 provided by user 206. Query 234 is a request for information or action. In this illustrative example, query 234 includes textual information 252 that may relate to a number of critical events. Critical events are occurrences that significantly disrupt normal operations, endanger lives, damage infrastructure, or threaten societal stability. For example, critical events can include natural disasters such as earthquakes, hurricanes, floods, wildfires, and tsunamis, industrial and technological incidents such as chemical spills or explosions, nuclear accidents, and cybersecurity incidents, national security threats such as terror attacks and political assassinations, public health crises such as pandemic and outbreak of infectious diseases, environmental crises such as oil spill and industrial pollution, or any natural or human-induced events that significantly disrupt normal operations, endanger lives, damage infrastructure, or threaten societal stability.

In this illustrative example, model manager 220 filters symbolic knowledge representations 228 to identify portion of symbolic knowledge representation 246 based on high-resolution spatiotemporal information from textual information 252. Portion of symbolic knowledge representation 246 is part of symbolic knowledge representation 226 that is directly related to the concepts in textual information. In other words, model manager 220 can identify concepts from textual information 252 using techniques such as keyword search to identify portion of symbolic knowledge representation 246, which is directly associated with the identified concepts from textual information 252. Model manager 220 can also implement other algorithms, including graph traversal algorithms, to ensure that all portions of symbolic knowledge representation 226 relevant to textual information 252 are present in portion of symbolic knowledge representation 246.

In this illustrative example, model manager 220 generates response 232 for query 234 using second large language model 258 based on portion of symbolic knowledge representation 246. In this example, second large language model 258 is specifically tailored to process queries by utilizing logical relationships derived from symbolic knowledge representations 228.

In this illustrative example, second large language model 258 can be obtained by using an off-the-shelf large language model with the capability to perform graph retrieval augmented generation (Graphical RAG). In an alternative illustrative example, second large language model 258 can be obtained by training and finetuning a large language model that is optimized for translating graph edges and nodes to natural languages.

In a similar fashion, second large language model 258 can be finetuned by converting symbolic knowledge representations 228 back to natural language. In this illustrative example, model manager 220 can evaluate and validate performance and accuracy for second large language model 258 by comparing set of data 230 with the natural languages generated from converting symbolic knowledge representations 228 using second large language model 258. Subsequently, model manager 220 can adjust parameters for second large language model 258 based on the comparison for optimizing second large language model 258.

In this illustrative example, model manager 220 validates response 232 before sending it back to user 206. Response 232 can be validated by model manager 220 in a number of ways. For example, model manager 220 can generate symbolic knowledge representation 226 using response 232. Subsequently, model manager 220 can compare symbolic knowledge representation 226 with portion of symbolic knowledge representation 246 to generate similarity score 224. In other words, model manager 220 validates response 232 by recreating symbolic knowledge representation 226 using textual information from response 232 and determining whether similarity score 224 for symbolic knowledge representation 226 and portion of symbolic knowledge representation 246 is beyond a pre-defined threshold.

The situation where similarity score 224 exceeds the pre-defined threshold indicates that portion of symbolic knowledge representation 246 is similar to symbolic knowledge representation 226, which in turn means that the concepts and logical relationships between concepts in both response 232 and textual information 252 are similar. As a result, response 232 can be validated. In this illustrative example, model manager 220 returns response 232 to user 206 when response 232 is validated.

On the other hand, the situation where similarity score 224 does not exceed the pre-defined threshold indicates that portion of symbolic knowledge representation 246 is not similar to symbolic knowledge representation 226, which in turn means that the concepts and logical relationships between concepts in both response 232 and textual information 252 are not similar. As a result, response 232 cannot be validated.

In this illustrative example, a new response can be generated by automatically resubmitting query 234. This can result in generation of the new response because LLMs sample from a distribution, and samples will not always be identical. Alternatively, differences between symbolic knowledge representation 226 and portion of symbolic knowledge representation 246 can be included in a new query to optimize second large language model 258.

In an alternative illustrative example, response 232 can also be validated by detecting misinformation and disinformation in response 232 based on deductive reasoning or approximate deductive reasoning for response 232 to look for self-consistency. Deductive reasoning can be achieved by analyzing the logical relationships contained on edges 250 in symbolic knowledge representations 228 to identify contradictory statements.

In addition, approximate deductive reasoning can be achieved by using an LLM to identify logical inconsistencies between statements represented in symbolic knowledge representation 226. In this illustrative example, symbolic knowledge representations 228 and portion of symbolic knowledge representation 246 can be purposely mutated with false information to validate procedures for detecting misinformation and disinformation. In this illustrative example, model manager 220 can evaluate whether machine learning models 242 is able to detect the false information through approximate deductive reasoning. In an alternative illustrative example, a reasoning engine can be used to detect false information in symbolic knowledge representation 226 through deductive reasoning.

In this illustrative example, it should be understood that existing techniques to validate output of an LLM using another LLM can include breaking the output into logical statements and then individually judging the accuracy of each logical statement. However, this process still relies on using an LLM to perform logical reasoning, and the LLM that validates output can hallucinate in the same way as the output-producing LLM can hallucinate, which renders the validation useless. Additionally, the process of breaking an output into logical statements may remove context that is important for determining if the fact is true. By contrast, the instant disclosure describes a method to convert the output of output-producing LLM into a symbolic knowledge representation and compare it to existing ground-truth symbolic knowledge representation. By such a method, important context for interpreting facts can be maintained and hallucinations of LLMs can be minimized by limiting the amount of logical reasoning that LLMs need to perform.

In this illustrative example, users such as user 206 can interact with computer system 204 through user inputs to computer system 204. For example, computer system 204 can receive user input 208 that includes query 234 which further includes textual information 252 for generating portion of symbolic knowledge representation 246.

In this illustrative example, user input 208 can be generated by user 206 using human machine interface (HMI) 210. As depicted, human machine interface 210 includes display system 238 and input system 240. Display system 238 is a physical hardware system and includes one or more display devices on which graphical user interface 254 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 254 through user input 208 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view symbolic knowledge representations 228, portion of symbolic knowledge representation 246, query 234, and response 232.

In one illustrative example, one or more solutions are present that overcome a problem with validating a response for a query related to a number of critical events. As a result, one or more technical solutions may provide an ability to increase the efficiency for validating information using high-resolution spatiotemporal data contained in query 234 such that misinformation provided by machine learning models 242 can be avoided.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 220 in computer system 204 enables automation of validating information using spatiotemporal information contained in query 234. In particular, model manager 220 transforms computer system 204 into a special purpose computer system as compared to currently available general computer systems that do not have model manager 220.

In the illustrative example, the use of model manager 220 in computer system 204 integrates processes into a practical application for processing queries related to critical events. In this illustrative example, model manager 220 improves efficiency and accuracy of queries processing. In other words, model manager 220 in computer system 204 is directed to a practical application of processes integrated into model manager 220 in computer system 204 that quickly and accurately process queries. In this illustrative example, model manager 220 improves functioning of computer system 204 by swiftly providing accurate responses and outputs.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, model manager 220 can further improve the efficiency and accuracy of first large language model 256 by using scripted questions to facilitate conversion between text and symbolic knowledge representation via prompt engineering. As a result, issues such as hallucinations can be minimized to further improve accuracy and efficiency for first large language model 256.

It should also be understood that first large language model 256 and second large language model 258 are only examples of machine learning models that can be used for implementing the method depicted above. In this illustrative example, other types of machine learning models such as multimodal language models can also be used for implementing the method depicted above.

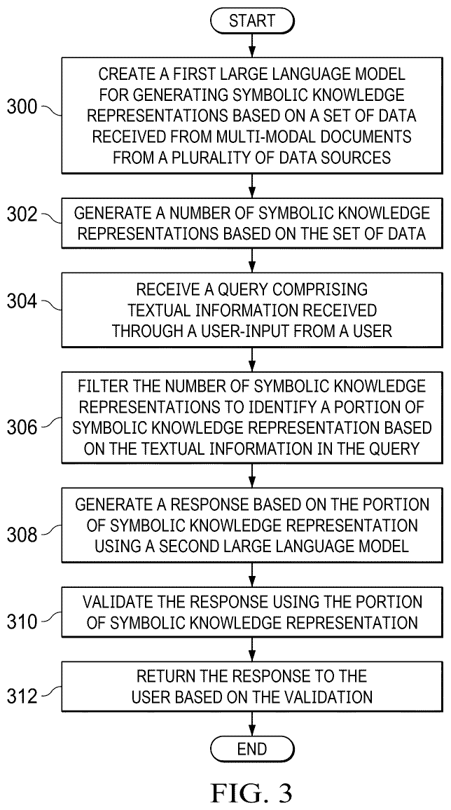

With reference now to FIG. 3, a flowchart illustrating a process for generating response for a query from a user is shown in accordance with an illustrative embodiment. The process in FIG. 3 can be implemented in hardware, software, or both. When implemented in software, the process can take the form of program instructions that are run by one of more processor units located in one or more hardware devices in one or more computer systems. For example, the process can be implemented in model manager 220 in computer system 204 in FIG. 2.

The process begins by creating a first large language model for generating symbolic knowledge representations based on a set of data received from multi-modal documents from a plurality of data sources (step 300). The process generates a number of symbolic knowledge representations based on the set of data (step 302). In step 302, each node in the number of symbolic knowledge representations represents a concept and each edge in the number of symbolic knowledge representations represents a relationship between concepts.

The process receives a query comprising textual information received through a user-input from a user (step 304). The process filters the number of symbolic knowledge representations to identify a portion of symbolic knowledge representation based on the textual information in the query (step 306).

The process generates a response based on the portion of symbolic knowledge representation using a second large language model (step 308). The process validates the response using the portion of symbolic knowledge representation (step 310). The process returns the response to the user based on the validation (step 312). The process terminates thereafter.

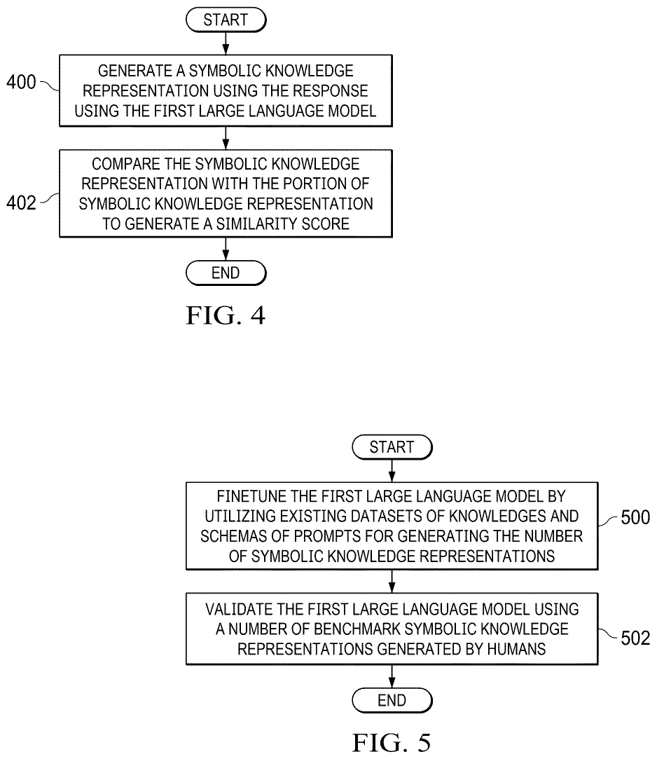

With reference now to FIG. 4, a flowchart illustrating a process for validating the response is shown in accordance with an illustrative embodiment. The process in this flowchart is an example of an implementation for step 310 in FIG. 3.

The process begins by generating a symbolic knowledge representation using the response using the first large language model (step 400). The process compares the symbolic knowledge representation with the portion of symbolic knowledge representation to generate a similarity score (step 402). The process terminates thereafter.

In step 402, the response generated for the query can be validated in response to determining that the similarity score exceeds a pre-defined threshold. On the other hand, the response generated for the query cannot be validated in response to determining that the similarity score does not exceed a pre-defined threshold.

With reference now to FIG. 5, a flowchart illustrating a process for finetuning the first large language model is shown in accordance with an illustrative embodiment. The process in this flowchart is an example of an implementation for step 300 in FIG. 3.

The process begins by finetuning the first large language model by utilizing existing datasets of knowledges and schemas of prompts for generating the number of symbolic knowledge representations (step 500). The process validates the first large language model using a number of benchmark symbolic knowledge representations generated by humans (step 502). The process terminates thereafter.

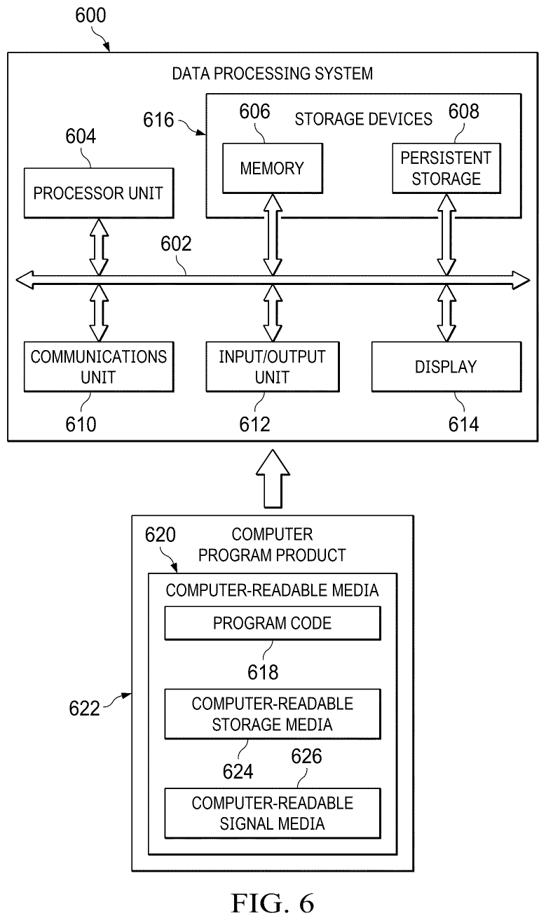

With reference now to FIG. 6, an illustration of a block diagram of a data processing system is depicted in accordance with an illustrative embodiment. Data processing system 600 may be used to implement server computer 104 and server computer 106 and client devices 110 in FIG. 1, as well as computer system 204 in FIG. 2. In this illustrative example, data processing system 600 includes communications framework 602, which provides communications between processor unit 604, memory 606, persistent storage 608, communications unit 610, input/output unit 612, and display 614. In this example, communications framework 602 may take the form of a bus system.

Processor unit 604 serves to execute instructions for software that may be loaded into memory 606. Processor unit 604 may be a number of processors, a multi-processor core, or some other type of processor, depending on the particular implementation. In an embodiment, processor unit 604 comprises one or more conventional general-purpose central processing units (CPUs). In an alternate embodiment, processor unit 604 comprises one or more graphical processing units (GPUs).

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer-usable program code, or computer-readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Computer-readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 618 may be transferred to data processing system 600 using computer-readable signal media 626. Computer-readable signal media 626 may be, for example, a propagated data signal containing program code 618. For example, computer-readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical applications, and to enable others of ordinary skill in the art to understand the disclosure for various embodiments with various modifications as are suited to the particular use contemplated.

1. A computer implemented method comprising:
creating, by a processor set, a first large language model for generating symbolic knowledge representations based on a set of data received from multi-modal documents from a plurality of data sources;
generating, by the processor set, a number of symbolic knowledge representations based on the set of data, wherein each node in the number of symbolic knowledge representations represents a concept and each edge in the number of symbolic knowledge representations represents a relationship between concepts;
receiving, by the processor set, a query comprising textual information received through a user-input from a user;
filtering, by the processor set, the number of symbolic knowledge representations to identify a portion of symbolic knowledge representation based on the textual information in the query;
generating, by the processor set using a second large language model, a response based on the portion of symbolic knowledge representation;
validating, by the processor set, the response using the portion of symbolic knowledge representation; and
returning, by the processor set, the response to the user based on the validation.

2. The computer implemented method of claim 1, wherein validating, by the processor set, the response using the portion of symbolic knowledge representation comprises:
generating, by the processor set using the first large language model, a symbolic knowledge representation using the response;
comparing, by the processor set, the symbolic knowledge representation with the portion of symbolic knowledge representation to generate a similarity score; and
in response to determining that the similarity score exceeds a pre-defined threshold, validating, by the processor set, the response generated for the query.

3. The computer implemented method of claim 1, wherein creating, by a processor set, a first large language model for generating symbolic knowledge representations based on a set of data received from multi-modal documents from a plurality of data sources comprises:
finetuning, by the processor set, the first large language model by utilizing existing datasets of knowledges and schemas of prompts for generating the number of symbolic knowledge representations; and
validating, by the processor set, the first large language model using a number of benchmark symbolic knowledge representations generated by humans.

4. The computer implemented method of claim 1, wherein the portion of symbolic knowledge representation is generated by performing filtering based on spatiotemporal information from the textual information in the query.

5. The computer implemented method of claim 1, wherein the set of data received from a plurality of data sources comprises sensor data.

6. The computer implemented method of claim 1, wherein the response is validated by detecting misinformation and disinformation in the response based on deductive reasoning or approximate deductive reasoning for the response.

7. The computer implemented method of claim 1, wherein the first large language model incorporates multi-modal language models (MLLMs) for processing the set of data.

8. A computer system, comprising:
a processor set;
a set of one or more computer-readable storage media; and
program instructions stored on the set of one or more storage media to cause the processor set to perform operations comprising:
creating a first large language model for generating symbolic knowledge representations based on a set of data received from multi-modal documents from a plurality of data sources;
generating a number of symbolic knowledge representations based on the set of data, wherein each node in the number of symbolic knowledge representations represents a concept and each edge in the number of symbolic knowledge representations represents a relationship between concepts;
receiving a query comprising textual information received through a user-input from a user;
filtering the number of symbolic knowledge representations to identify a portion of symbolic knowledge representation based on the textual information in the query;
generating a response based on the portion of symbolic knowledge representation using a second large language model;
validating the response using the portion of symbolic knowledge representation; and
returning the response to the user based on the validation.

9. The computer system of claim 8, wherein validating the response using the portion of symbolic knowledge representation comprises:
generating a symbolic knowledge representation using the response using the first large language model;
comparing the symbolic knowledge representation with the portion of symbolic knowledge representation to generate a similarity score; and
in response to determining that the similarity score exceeds a pre-defined threshold, validating the response generated for the query.

10. The computer system of claim 8, wherein creating a first large language model for generating symbolic knowledge representations based on a set of data received from multi-modal documents from a plurality of data sources comprises:
finetuning the first large language model by utilizing existing datasets of knowledges and schemas of prompts for generating the number of symbolic knowledge representations; and
validating the first large language model using a number of benchmark symbolic knowledge representations generated by humans.

11. The computer system of claim 8, wherein the portion of symbolic knowledge representation is generated by performing filtering based on spatiotemporal information from the textual information in the query.

12. The computer system of claim 8, wherein the set of data received from a plurality of data sources comprises sensor data.

13. The computer system of claim 8, wherein the response is validated by detecting misinformation and disinformation in the response based on deductive reasoning or approximate deductive reasoning for the response.

14. The computer system of claim 8, wherein the first large language model incorporates multi-modal language models (MLLMs) for processing the set of data.

15. A computer program product, comprising:
a set of one or more computer-readable storage media;
program instructions stored in the set of one or more computer-readable storage media to perform operations comprising:
creating, by a processor set, a first large language model for generating symbolic knowledge representations based on a set of data received from multi-modal documents from a plurality of data sources;
generating, by the processor set, a number of symbolic knowledge representations based on the set of data, wherein each node in the number of symbolic knowledge representations represents a concept and each edge in the number of symbolic knowledge representations represents a relationship between concepts;
receiving, by the processor set, a query comprising textual information received through a user-input from a user;
filtering, by the processor set, the number of symbolic knowledge representations to identify a portion of symbolic knowledge representation based on the textual information in the query;
generating, by the processor set using a second large language model, a response based on the portion of symbolic knowledge representation;
validating, by the processor set, the response using the portion of symbolic knowledge representation; and
returning, by the processor set, the response to the user based on the validation.

16. The computer program product of claim 15, wherein validating, by the processor set, the response using the portion of symbolic knowledge representation comprises:
generating, by the processor set using the first large language model, a symbolic knowledge representation using the response;
comparing, by the processor set, the symbolic knowledge representation with the portion of symbolic knowledge representation to generate a similarity score; and
in response to determining that the similarity score exceeds a pre-defined threshold, validating, by the processor set, the response generated for the query.

17. The computer program product of claim 15, wherein creating, by a processor set, a first large language model for generating symbolic knowledge representations based on a set of data received from multi-modal documents from a plurality of data sources comprises:
finetuning, by the processor set, the first large language model by utilizing existing datasets of knowledges and schemas of prompts for generating the number of symbolic knowledge representations; and
validating, by the processor set, the first large language model using a number of benchmark symbolic knowledge representations generated by humans.

18. The computer program product of claim 15, wherein the portion of symbolic knowledge representation is generated by performing filtering based on spatiotemporal information from the textual information in the query.

19. The computer program product of claim 15, wherein the response is validated by detecting misinformation and disinformation in the response based on deductive reasoning or approximate deductive reasoning for the response.

20. The computer program product of claim 15, wherein the first large language model incorporates multi-modal language models (MLLMs) for processing the set of data.
